(19) United States
(12) Patent Application Publication
(10) Pub. No.: US 2007/0149708 A1
(43) Pub. Date: Jun. 28, 2007

(54) Water-disintegrable enviromentally friendly macromolecular blend materials and the process for preparation thereof

(75) Inventors: Shanpu Yu, Qingdao (CN); Fugui Xu, Jimo (CN); Yuyong Liu, Qingdao (CN); Zhaoge Huang, Qingdao (CN); Xianzong Shi, Qingdao (CN)

Correspondence Address: CONNOLLY BOVE LODGE & HUTZ, LLP, P O BOX 2207, WILMINGTON, DE, 19899, US

(73) Assignee: Polymer Science & Engineering College of Quingdao University of Science & Technolgy

(21) Appl. No.: 10/570,976

(22) PCT Filed: Sep. 2, 2004
(86) PCT No.: PCT/CN04/01011

§ 371 Date: Nov. 13, 2006

(30) Foreign Application Priority Data
Sep. 9, 2003 (CN) 03139221.0

(51) Int. Cl. C08L 33/06; C08L 33/24

(52) U.S. Cl. 525/212; 525/218; 525/222; 525/232; 524/306

(57) ABSTRACT

The present invention relates to a novel water-disintegrable environment-friendly macromolecular material formed by blending water absorbent resin particles into polymers, such as polystyrene. Said material will disintegrate into powder or lose its intensity at a certain rate in the presence of water. The present invention also relates to two kinds of processes for preparing said material. The first process is called blending-polymerization process, wherein water absorbent resin particles with particle size not more than 5 μm, together with an initiator, are added into one or more monomers, such as styrene, to carry out polymerization. The second process is called reverse-phase emulsion polymerization process, wherein a W/O emulsion was firstly formed by agitating a mixture of one or more oil-soluble monomers, such as styrene, one or more water-soluble monomers that will form water-absorbent polymer after polymerization, such as sodium acrylate and methylene bisacrylamide, water, initiators and a W/O emulsifer, and then a polymerization was carried out. The material of the present invention has advantages that its preparation involves low cost, and its water-disintegrating rate is controllable. The material of the present invention can be used to replace the currently used foamed polystyrene type packing materials, especially the packing materials for disposable meal boxes, which are pollutive and difficult to be recycled and degraded.

### FIELD OF THE INVENTION

The present invention relates to a macromolecular material, in particular, an environment-friendly macromolecular material formed by blending water-absorbent resin particles into a rigid, especially foamed polymer, such as polystyrene, polymethyl methacrylate, polychloroethylene or polyethylene. Said material will disintegrate into powder or lose its intensity at a certain rate over a certain time in the presence of water. The present invention also relates to processes for preparing the same.

### BACKGROUND OF THE INVENTION

As the negative consequences of environmental pollution are realized more clearly, it is of necessity to modify pollutive macromolecular materials to make them friendly to the environment. Currently, foamed polystyrene materials, which are used as packing liners of various household appliances and disposable meal boxes, constitute one of the primary white-pollution sources due to their low specific density, easy movement by wind and water, and difficulties in recovery and degradation.

It has been reported that processes for modifying such materials to make them non-pollutive are mainly as follows: addition of photo-degradation agent into the materials so as to cause the materials to be gradually degraded under light; blending of starch, cellulose, and the like into the materials so that the materials can be gradually degraded or lost intensity through the action of microorganism; and so on. All of these processes have disadvantages, such as long degradation time, uncontrollable degradation rate, great difficulties in processing and high cost, which render them hard to be widely used. Therefore, there is still a need for solving the pollution problem caused by foamed polystyrene.

### SUMMARY OF THE INVENTION

The object of the present invention is to overcome the above-mentioned disadvantages and provide a novel water-disintegrable environment-friendly macromolecular material, and processes for preparing the same. The rate of disintegration into powder and the rate of losing intensity of the material can be determined by the content, dispersion state and expansion capacity of the water-absorbent resin. Since the preparation processes of the novel material can be readily conducted with lower cost, and the water disintegration rate can be controlled, the. novel material is especially suitable for replacing the currently used foamed polystyrene package and disposable packing materials such as disposable meal boxes, which are heavily pollutive and difficult to be recycled and degraded.

The above object is achieved by the polymerization a mixture of one or more oil-soluble monomers, which will form a rigid plastic after polymerization, water-absorbent polymer particles and a blending dispersant. The water absorbent polymer particles, have an average particle size of not more than 5 μm. The mixture for polymerization comprises 7.5-25 wt % of the water-absorbent polymer particles, 0.5-15 wt % of the blending dispersant, and the balance is consisted of the monomers, which will form a rigid plastic after polymerization, and a small amount of initiator. The monomers, which will form a rigid plastic after polymerization, comprise ethylene, styrene, chloroethylene, methyl methacrylate and vinyl acetate. The obtained rigid plastic can also be a copolymer having no crosslinked structure formed from two or more of the above-mentioned monomers. The water-absorbent polymer particles comprise crosslinked polymer particles formed by homopolymerization or copolymerization of one or more water-soluble monomers such as methacrylate, methacrylamide, and sodium propylene sulfonate, with one of crosslinkable monomers, such as methylene bisacrylamide and itaconate. The blending dispersant comprises one or more sorbitan esters with low HLB value, such as SPAN-80, SPAN-60 and SPAN-85, or it can be a composition of a sorbitan ester with a TX type or a OP type polyethylene oxide ether surfactant having high HLB value.

The rigid plastic formed by the polymerization can also be a toughened copolymer having no crosslinked structure formed from one or more of ethylene, styrene, chloroethylene, methyl methacrylate and vinyl acetate, with a small amount of one or more of ethyl acrylate, butyl acrylate, 2-ethyl hexyl acrylate, butadiene and isoprene.

The water-absorbent polymer particles can also be a crosslinked copolymer formed from a natural macromolecular material, such as starch and cellulose, graft-modified with a water-soluble monomer, or it can be a product formed from a natural macromolecular material, such as starch and cellulose, graft-copolymerized with acrylonitrile, followed by hydrolyzation and saponification.

The initiator is selected from a group consisting of BPO type peroxides, AIBN type azo compounds, persulphate type inorganic peroxides, and oxidation-reduction systems formed of peroxides with alkyl metallic compounds.

It was found by the inventor that after water-absorbent resin particles containing no or a small amount of water were blended into a rigid plastic, such as polystyrene, the plastic would disintegrate into powder or lose intensity due to the expansion effect of the water-absorbent resin particles in the presence of water, and that the rate of disintegrating into powder and the rate of losing intensity could be controlled by the content, dispersion state and expansion capacity of the water-absorbent resin. Thus, a fully novel water-disintegrable environment-friendly macromolecular material has been invented.

Also, the preparation processes of the above said material have been invented firstly by the inventor.

The first preparation process of the material of the present invention is called monomer-polymer blending polymerization, comprising the following steps:

1. Adding a blending dispersant and an initiator, such as BPO, into one or more monomers, which will form a rigid plastic after polymerization, heating the resultant mixture to 60° C. so as to dissolve the blending dispersant;

2. Further adding water-absorbent polymer particles with particle size not more than 1 μm, and stirring the resultant mixture for uniformity;

3. Introducing into the system highly pure nitrogen to evacuate oxygen and then carrying out polymerization for 2 hours; and

4. Raising the temperature to 70° C. and conducting the polymerization for another 2 hours.

The second preparation process is called reverse-phase emulsion polymerization, comprising the following steps: adding a W/O blending emulsifier into one or more oil-soluble monomers, which will form a rigid plastic after polymerization, heating the resultant mixture to 60° C. so as to dissolve the blending emulsifier; further adding water, one or more water-soluble monomers, such as sodium(meth)acrylate, acrylamide and sodium propylene sulfonate, a small amount of a crosslinkable monomer, such as methylene bisacrylamide and sodium itaconate, as well as two kinds of initiators dissolvable in oil phase and in water phase respectively; stirring violently to emulsify the mixture system, introducing highly pure nitrogen to evacuate oxygen and making each of the monomers in the two phases of the emulsified system polymerize simultaneously or in sequence; and raising the temperature and conducting the polymerization further. Specifically, the steps are as follows:

1. Adding a blending dispersant into one or more oil-soluble monomers, which will form a rigid plastic after polymerization, heating the resultant mixture to 60° C. so as to dissolve the blending dispersant, adding a small amount of an oil-soluble initiator (0.1%-1 wt % with respect to the oil-soluble monomers);

2. Adding 7%-25 wt % of one or more water-soluble monomers with respect to the oil-soluble monomers, 0.05%-0.5 wt % of a water-soluble crosslinkable monomer with respect to the water-soluble monomers, 0.1%-1 wt % of a water-soluble initiator with respect to the water-soluble monomers, and deionized water 2.5-3.5 times relative to the water-soluble monomers;

3. Introducing highly pure nitrogen to evacuate oxygen for 0.5 hours; and

4. Raising the temperature to carry out polymerization, i.e. raising the temperature to 60° C. and conducting polymerization for 2 hours, and then raising the temperature to 80° C. and conducting polymerization for another 2 hours.

In the above two processes, the first one for preparing the inventive material is called monomer-polymer blending polymerization, wherein adding fine water-absorbent polymer particles and a blending dispersant into one or more oil-soluble monomers, which will form a rigid plastic after polymerization, such as styrene, and carrying out the polymerization so as to make the fine water-absorbent polymer particles being evenly dispersed in the obtained polymer, such as polystyrene. The main factors that influence the preparation of the material of the present invention in this process comprise the particle size, the capacity of absorbing water and the adding amount of the fine water-absorbent polymer particles, the amount and properties of the dispersant added, as well as the polymerization conditions. Compared with conventional mechanical blending process, the present process does not include a mechanical blending procedure, and overcomes the defect that it is difficult for blending strongly polar fine water-absorbent polymer particles into water-insoluble polymers evenly and said particles may have negative effects on the physical-mechanical properties of the water-insoluble polymers after blending thereinto. The present process also ensures desirable properties of the obtained polymer, such as polystyrene, by selecting the polymerization conditions according to requirements.

In the first process, the monomers, which will form a rigid plastic after polymerization, comprise ethylene, styrene, chloroethylene, methyl methacrylate, vinyl acetate and the like, and it is possible to copolymerize these monomers or copolymerize these monomers with a small amount of other monomers, which will form flexible polymers after polymerization, such as ethyl acrylate, butyl acrylate, 2-ethyl hexyl acrylate, butadiene, isoprene and the like, so as to increase the toughness of the resultant polymers. The final polymers contain no crosslinked structures and can disintegrate in the presence of water, and they are unlike elastomers, such as rubbers, which are only swollen but do not disintegrate after water absorption even when water-absorbent polymer particles have been blended thereinto.

Said fine water-absorbent polymer particles comprise crosslinked homopolymer or copolymer formed from one or more water-soluble monomers, such as (meth)acrylate, (meth)acrylamide, sodium propylene sulfonate, and the like, with a crosslinkable monomer, such as methylene bisacrylamide, itaconate and the like. The water-absorbent polymer can also be a crosslinked copolymers of a natural macromolecular material, such as starch and cellulose, graft-modified with one or more of the above-mentioned water-soluble monomers, or it can be a grafted copolymer of a natural macromolecular material with acrylonitrile, followed by hydrolyzation and saponification. The fine water-absorbent polymer particles containing natural macromolecular material component therein further impart biodegradability to the material of the present invention. Thus, it is possible to add a small amount of the fine water-absorbent polymer particles during the preparation of the material of the present invention, so as to produce a macromolecular material, which do not disintegrate readily in the presence of water, but can rapidly degrade in the presence of microorganisms, thereby shortening the degradation time of the material. Depending on the water-absorbing capacity of the fine water-absorbent polymer particles, the blending conditions, the applied amount and properties of the dispersant, the minimum weight percentage of the fine water-absorbent polymer particles in the rigid plastic is different and is generally around 8%. If it is lower than said range, the blend material will not disintegrate in the presence of water. If it is higher than said range, the water disintegration rate of the blend material will be too rapid. The particle size of the fine water-absorbent polymer particles is as small as possible, and generally not more than 5 μm. Smaller particle size not only reduce the influence of the added water-absorbent polymer particles on the physical-mechanical properties of the product, but also reduce the applied amount of the water-absorbent polymer particles for achieving the same water disintegration rate.

Said blending dispersant comprises surfactants with low HLB value, such as SPAN-80, SPAN-60, SPAN-85 and the like. In order to achieve the optimum effect, it is sometimes necessary to further add a surfactant with high HLB value, such as TX-10. The applied amount of the blending dispersant is generally 0.5%-5 wt % with respect to the weight of the material of the present invention. The properties and applied amount of the dispersant not only affect the dispersion of the fine water-absorbent polymer particles in the material, but also affect the water-disintegration rate thereof. It is therefore important in the present process to select suitable dispersant and polymerization conditions.

The polymerization in the first process is generally a free radical polymerization. The type of the added initiator and the applied amount thereof are determined according to the desired molecular weight and molecular weight distribution of the polymer, as well as the polymerization conditions. Applicable initiator comprises peroxides, such as BPO, azo compounds, such as AIBN, and oxidation-reduction systems formed from peroxides and alkyl metallic compounds.

The second process for preparing the material of the present invention is called reverse-phase emulsion polymerization, wherein one or more oil-soluble monomers, such as styrene and the like, are used as oil phase, and one or more water-soluble monomers, such as acrylate, methylene bisarylamide, and the like, are used as water phase, and a W/O emulsifier, an oil-soluble initiator and a water-soluble initiator are added into the oil phase and the water phase, and then the resultant mixture is subjected to agitation to obtain a stable reversed phase emulsion, then making the monomers in the two phases polymerize simultaneously or in sequence to form a water-disintegrable environment-friendly macromolecular material, wherein hydrogel particles are evenly and stably dispersed in the macromolecular material. Said material may or may not be subjected to dehydration. In comparison with the first process, the advantage of this process lies in that the properties of the water-absorbent polymers and the porperties of the final materials, such as blended polystyrene, can be determined by selecting conditions according to requirements. It is preferable that water is used as a foaming agent or as one of the components of a foaming agent.

The oil-soluble monomers used in the second process are the same as those used in the first process, and the water-soluble monomers used in the second process are the same as those monomers (raw material) used for forming the fine water-absorbent polymer particles in the first process. When starch and cellulose are used, it is necessary to add, for example, urea or sodium hydroxy, to make them dissolved in water to facilitate the emulsification. During polymerization, it is possible to firstly polymerize the monomers in water phase or to polymerize the monomers in both phases simultaneously. For a system that is well emulsified and no phase separation happened for a long time, the polymerization is carried out by adding an oil-soluble initiator and a water-soluble initiator respectively into the two phases, followed by heating. For an emulsion system without high stability, it is necessary to carry out polymerization at elevated temperature with agitation and keep agitating until the monomers, such as styrene, in the oil phase polymerize to a certain conversion degree and the system has become viscous, so as to avoid the precipitation of the water phase, which would affect the uniformity of the polymers.

The oil-soluble initiator used in the second process is the same as that used in the first process. But it is preferable to use a peroxide, such as BPO, alone since when alkyl metallic compound is used as reductant in the oxidation-reduction initiation system, due to the water contained in the system, the efficiency is low. The initiator for the water phase is generally an inorganic peroxide, such as potassium persulphate, ammonium persulphate, hydrogen peroxide and the like, and it can also be an oxidation-reduction initiation system formed by any of the above-mentioned peroxides with iron(II) sulphate, sodium thiosulphate or the like.

The weight ratio of the monomers in the oil phase and the monomers in the water phase is between 90:10 and 10:90, and when the ratio varies, it is usually not required to change the emulsification conditions. However, when the ratio of the monomers in the water phase to water is changed, it is generally necessary to adjust the emulsifier and emulsification conditions and even polymerization conditions. Therefore, it is preferable to firstly determine the ratio between the monomers in the oil phase and the monomers in the water phase according to the desired water disintegration rate of the product and then determine the ratio of the monomers in the water phase to water according to the requirements for polymerization stability.

The second process generally utilizes free radical polymerization, and it is necessary to evacuate oxygen and select appropriate initiator and polymerization conditions.

The material of the present invention is most applicable in packing materials for household appliances that need to be obviated long time contact with water, and also applicable in disposable meal boxes after surface water-proof treatment. The material can be made into films and foamed liners of various shapes. During the preparation of a foamed product, it is possible to directly add a foaming agent during the polymerization. In this case, the type and the applied amount of the foaming agent and the foaming conditions will determine the foaming properties of the product.

In the preparation of foamed materials, if conventional organic foaming agents are used, the first process is preferable, since it is possible to add a foaming agent into the monomers during the polymerization, and conduct a direct polymerization and granulation. In the second process, water can be used as a foaming agent, so that little or no organic foaming agent is needed and the environment pollution caused by the organic foaming agent is reduced.

### BRIEF DESCRIPTION OF THE DRAWINGS

FIG. 1 illustrates the water disintegration rates of the materials obtained in examples 1-5 (wherein the contents of polyacrylate are different) at 30° C.;

FIG. 2 illustrates the water disintegration rate of the materials obtained in examples 6-10 (wherein the W/O ratios are different) at 20° C.; and

FIG. 3 illustrates the water disintegration rate of the materials obtained in examples 6-10 (wherein the W/O ratios are different) at 60° C.

### DETAILED DESCRIPTION OF THE INVENTION

### EXAMPLE 1

Preparation of a water-disintegrable environment-friendly macromolecular blend material by the first process.

93 g chemically pure styrene containing a polymerization retarder and 4 g SPAN-60 were charged into a 250 mL three-necked round-bottom flask. After the mixture was heated to 60° C. to dissolve SPAN-60, 7 g water-absorbent particles of sodium polyacrylate crosslinked with methylene bisacrylamide and 0.3 g dibenzoyl peroxide were added, wherein the water-absorbent particles had an average particle size of about 1 μm. Under agitation, highly pure nitrogen was introduced to evacuate oxygen, followed by 2-hour polymerization. After the temperature was raised to 70° C., the polymerization was conducted for another 2 hours, and a polystyrene blend containing 7% water-absorbent particles of crosslinked sodium polyacrylate was obtained. The blend had no change after being soaked in water at 30° C. for 12 hours, which demonstrated that when the polymerized product contains less than 7% water-absorbent polymer particles, it had no water disintegration property over the test time.

### EXAMPLE 2

Preparation of a water-disintegrable environment-friendly macromolecular blend material by the first process.

Polymerization was conducted in the same way as that in Example 1, except that the ratio of styrene to the water-absorbent polymer particles was changed so that the resultant blend material contained 8% water-absorbent particles of crosslinked sodium polyacrylate. After being soaked in water at the same temperature for 12 hours, the surface of the product turned white and its edge came into disintegration.

### EXAMPLES 3-5

Preparation of water absorbent environment-friendly macromolecular blend materials by the first process.

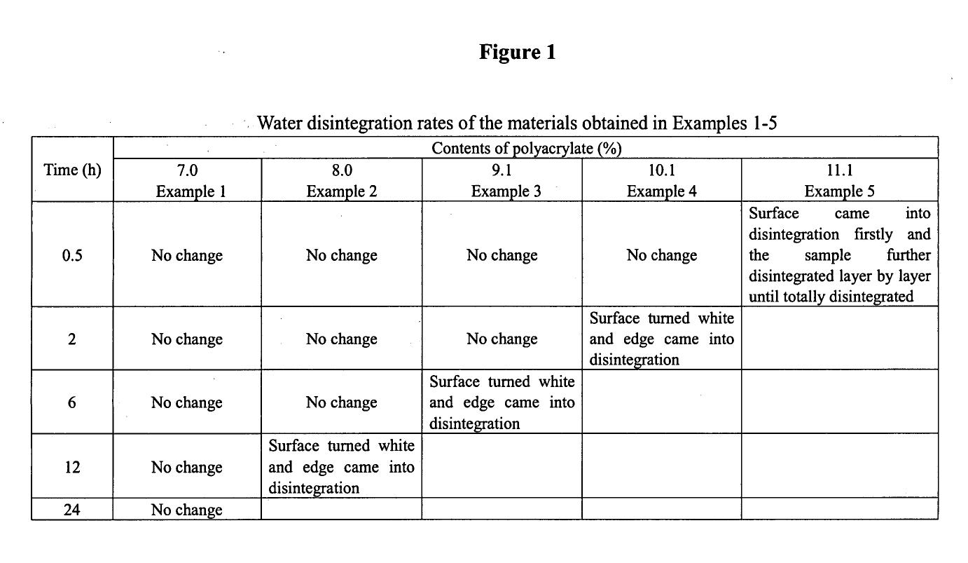

In each of these Examples, polymerization was conducted in the same way as that in Example 1, except that the content of the water-absorbent polymer particles in the blend material was further increased, and the water disintegration rate of the product was further improved. The detailed results are shown in FIG. 1.

### EXAMPLE 6

Preparation of a water-disintegrable environment-friendly macromolecular blend material by the second process.

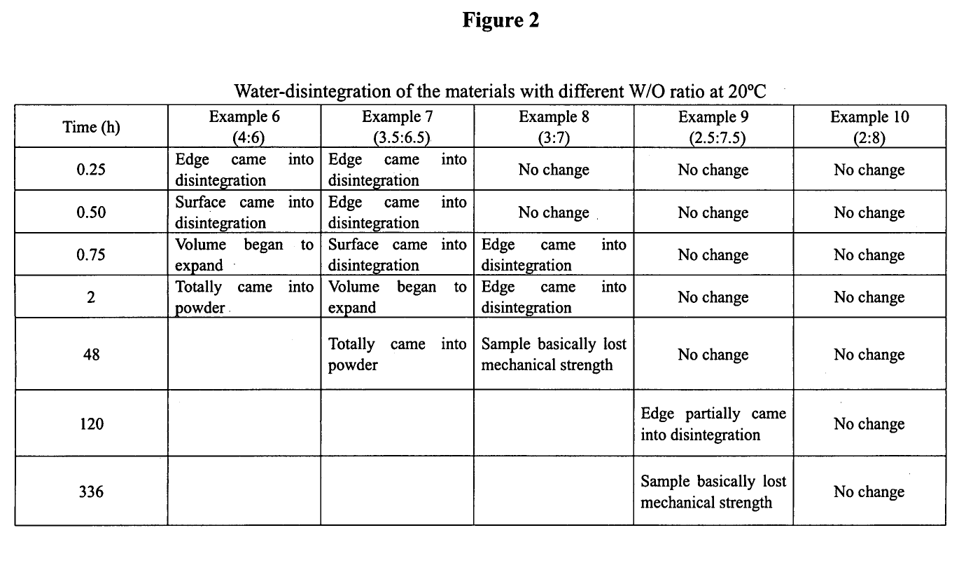

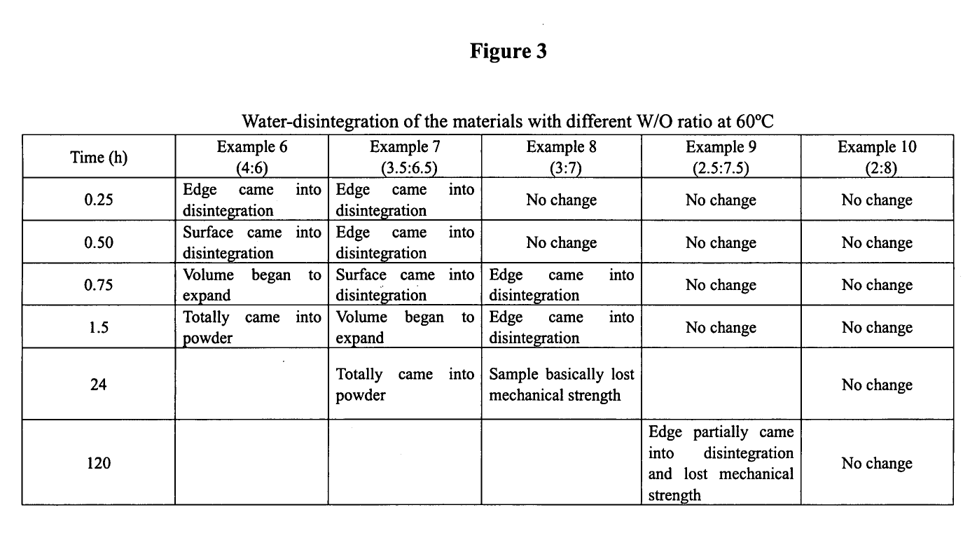

60 g styrene containing a small amount (0.01%) of hydroquinone, 2 g SPAN-60 and 0.18 g BPO were charged into a 250 mL round-bottom flask equipped with an agitator, a water bath and an inlet for nitrogen gas. After the mixture was heated to 60° C., a solution containing 15 g sodium acrylate, 25 g deionized water, 0.03 g potassium persulphate and 0.03 g methylene bisacrylamide were added. After violent agitation for 30 minutes, highly pure nitrogen was introduced to evacuate oxygen for 30 minutes, followed by 2-hour polymerization at 60° C. and a further 2-hour polymerization at 80° C. The disintegration properties of the resultant materials soaked in tap water at 20° C. and 60° C. respectively are shown in FIGS. 2 and 3.

### EXAMPLES 7-10

Preparation of a water-disintegrable environment-friendly macromolecular blend material by the second process.

In each of these examples, polymerization was conducted in the same way as that in Example 6, and the ratio between water and sodium acrylate and the ratio between the initiator and monomers in the two phases were not changed, except that the W/O ratio was varied. The water disintegration properties of the resultant materials are shown in FIGS. 2 and 3.

From FIG. 1, which shows the results of the first process for preparing the water-disintegrable material, it can be seen that when the material contains 8% of the water-absorbent polymer particles, it comes into disintegration after 12 hours, while when the material contains 11% of the water-absorbent polymer particles, it comes into disintegration after 30 minutes. From FIGS. 2-3, which show the results of the second process for preparing the water-disintegrable material, it can be seen that when the resultant material contains 25% of the water-absorbent polymer particles, its edge comes into disintegration after 15 minutes, while when the material contains 16% of the water-absorbent polymer particles, it comes into disintegration after 120 hours. It also can be seen that when the contents of the water-absorbent polymer particles in the resultant materials are the same, the products obtained by the second process have lower water disintegration rates than those obtained by the first process. The reason may lies in that the water-absorbent polymer particles obtained in the two preparation processes have different water absorption capacities and that part of the water-absorption capacity of the product produced by the second process is lost due to the product obtained by the second process already contains some water. It can be seen from the comparison of FIGS. 2 and 3 that temperature has little effect on the rate of water disintegration or losing intensity of the material of the present invention. Therefore, the material of the present invention can be used as an environment-friendly macromolecular material intended to be used under high temperature, such as disposable meal boxes. Furthermore, the polymerization of polystyrene in the continuous phase in the preparation of the material can utilize the conventional synthesis process of polystyrene, and thus the obtained material has little change in physical-mechanical properties so as to satisfy the requirements of replacing existing materials.

### EXAMPLE 11

Preparation of a water-disintegrable environment-friendly macromolecular blend material.

A macromolecular blend material was formed by carrying out polymerization of a mixture of one or more oil-soluble monomers, which would form a rigid plastic after polymerization, water-absorbent polymer particles with particle size not more than 5 μm, a blending dispersant and trace amount of BPO initiator. The mixture for the polymerization contained 25 wt % of the water-absorbent polymer particles and 0.5 wt % of the blending dispersant based on the total weight of the mixture, and the balance was consisted of the oil-soluble monomers and the initiator. Said oil-soluble monomers comprised styrene. Said water-absorbent polymer particles comprised crosslinked homopolymer or copolymer of methacrylate and crosslinkable methylene bisacrylamide monomer. Said blending dispersant comprised surfactant SPAN-80 with low HLB value.

### EXAMPLE 12

Preparation of a water-disintegrable environment-friendly macromolecular blend material.

A macromolecular blend material was formed by carrying out polymerization of the a mixture of one or more oil-soluble monomers, which would form a rigid plastic after polymerization, water-absorbent polymer particles with particle size not more than 1 μm, a blending dispersant and trace amount of AIBN initiator. The mixture for the polymerization contained 7.5 wt % of the water-absorbent polymer particles and 15 wt % of the blending dispersant, based on the total weight of the mixture, and the balance was consisted of the oil-soluble monomers and the initiator. Said oil-soluble monomers comprised methyl methacrylate. Said water-absorbent polymer particles comprised crosslinked copolymer of a water-soluble sodium propylene sulfonate monomer and a crosslinkable itaconate monomer. Said blending dispersant comprised surfactant SPAN-60 with low HLB value.

### EXAMPLE 13

Preparation of a water-disintegrable environment-friendly macromolecular blend material.

A macromolecular blending material was formed by carrying out polymerization of a mixture of one or more oil-soluble monomers, which would form a rigid plastic after polymerization, water-absorbent polymer particles with particle size not more than 1 μm, a blending dispersant and trace amount of BPO initiator. The mixture for the polymerization contained 9 wt % of the water-absorbent polymer particles and 5 wt % of the blending dispersant, based on the total weight of the mixture, and the balance was consisted of the oil-soluble monomers and the initiator.

Said oil-soluble monomers comprised ethylene and methyl methacrylate, and they could form a copolymer without crosslinked structure. The water-absorbent polymer particles comprised crosslinked copolymer of a water-soluble methacrylate monomer and a crosslinkable methylene bisacrylamide monomer. The blending dispersant comprised surfactant SPAN-60 with low HLB value.

The blend materials obtained in Examples 11-13 involve lower costs and have controllable water disintegration rate and therefore are especially suitable for replacing currently used packing materials, such as foamed polystyrene, which are heavily pollutive and have difficulties in recovery and degradation.

What is claimed is:

1. A water-disintegrable environment-friendly macromolecular blend material, characterized in that it is prepared by blending a mixture of a rigid plastic, such as polystyrene, water-absorbent polymer particles containing or not containing water, and a blending dispersant, wherein the water-absorbent polymer particles have an average particle size of not more than 5 μm, and said particles constitute 7.5-25 wt % of the total weight of the blend material, and the blending dispersant constitutes 0.5-15 wt % of the total weight of the blend material.

2. The water-disintegrable environment-friendly macromolecular blend material according to claim 1, characterized in that said rigid plastic is a polymer of one or more monomers selected from the group consisting of ethylene, styrene, chloroethylene, methyl methacrylate and vinyl acetate; said water-absorbent polymer particles comprise crosslinked polymer particles formed by homopolymerization or copolymerization of one or more water-soluble monomers, such as methacrylate, acrylate, methacrylamide, acrylamide, and sodium propylene sulfonate, with a crosslinkable monomer, such as methylene bisacrylamide and itaconate; and said blending dispersant comprises one or more dispersant selected from the group consisting of sorbitan esters with low HLB value, such as SPAN-80, SPAN-60 and SPAN-85, or it can be a composition of a sorbitan ester with a TX type or an OP type polyethylene oxide ether surfactant with high HLB value.

3. The water-disintegrable environment-friendly macromolecular blend material according to claim 1, characterized in that said rigid plastic is a toughened copolymer having no crosslinked structure and it is formed from one or more monomers selected from the group consisting of ethylene, styrene, chloroethylene, methyl methacrylate and vinyl acetate, copolymerized with a small amount of one or more monomers selected from the group consisting of ethyl acrylate, butyl acrylate, 2-ethylhexyl acrylate, butadiene and isoprene.

4. The water-disintegrable environment-friendly macromolecular blend material according to claim 1, characterized in that said water-absorbent polymer comprises a crosslinked copolymer of starch or cellulose graft-modified with a water-soluble monomer, and a product formed by starch or cellulose copolymerized with acrylonitrile, followed by hydrolyzation and saponification.

5. A process for preparing the water-disintegrable environment-friendly macromolecular blend material according to claim 1, characterized in that it is a monomer-polymer blending polymerization process comprising:
(1) Adding a blending dispersant and an initiator, such as BPO, into monomers, which will form a rigid plastic after polymerization, heating the resultant mixture to 60° C. so as to dissolve the blending dispersant;
(2) Further adding water-absorbent polymer particles with particle size not more than 1 μm and stirring the resultant mixture for uniformity;
(3) Introducing to the system highly pure nitrogen to evacuate oxygen and then carrying out polymerization for 2 hours; and
(4) Raising the temperature to 70° C. and conducting the polymerization for another 2 hours.

6. A process for preparing the water-disintegrable environment-friendly macromolecular blend material according to claim 1, which is a reverse-phase emulsion polymerization process comprising the following steps: adding a blending emulsifier and an oil-soluble initiator into one or more oil-soluble monomers, which will form a rigid plastic after polymerization, heating the resultant mixture to 60° C. so as to dissolve the blending emulsifier; further adding one or more water-soluble monomers, a crosslinkable monomer, water, and a water-soluble initiator; agitating the resultant mixture to emulsify the system; introducing highly pure nitrogen gas to evacuate oxygen and then carrying out polymerization; and raising the temperature to conduct the polymerization further, characterized in that:
(1) Adding a blending emulsifier into one or more oil-soluble monomers that will form a rigid plastic after polymerization, heating the resultant mixture to 60° C. so as to dissolve the blending emulsifier, and then adding 0.1%-1 wt % of an oil-soluble initiator with respect to the oil-soluble monomer;
(2) Further adding 15%-25 wt % of one or more water-soluble monomers with respect to the oil-soluble monomers, 0.05%-0.5 wt % of a water-soluble crosslinkable monomer with respect to the water-soluble monomers, 0.1%-1 wt % of a water-soluble initiator with respect to the water-soluble monomers, and deionized water 2.5-3.5 times relative to the water-soluble monomers;
(3) Introducing highly pure nitrogen gas to evacuate oxygen for 0.5 hours; and
(4) Raising the temperature to carrying out polymerization, i.e. raising the temperature to 60° C. and conducting a polymerization for 2 hours, and then raising the temperature to 80° C. and conducting the polymerization for another 2 hours.
